(19) United States
(12) Patent Application Publication
(10) Pub. No.: US 2024/0125937 A1
(43) Pub. Date: Apr. 18, 2024

(54) CAMERA SYSTEMS FOR OPERATING IN MULTIPLE OPTICAL CHANNELS

(71) Applicant: Microsoft Technology Licensing, LLC, Redmond, WA (US)

(72) Inventors: Cyrus Soli BAMJI, Fremont, CA (US); Onur Can AKKAYA, Palo Alto, CA (US); Sergio ORTIZ EGEA, San Jose, CA (US)

(73) Assignee: Microsoft Technology Licensing, LLC, Redmond, WA (US)

(21) Appl. No.: 18/047,453

(22) Filed: Oct. 18, 2022

(51) Int. Cl. G01S 17/894; G02F 1/31

(52) U.S. Cl. CPC G01S 17/894; G02F 1/31

(57) ABSTRACT

Indirect time-of-flight camera systems for operating in multiple optical channels using active modulated light and accompanying methods of operation are provided. In one aspect, the indirect time-of-flight camera system includes first and second modulatable laser sources outputting light of different wavelengths for illuminating a target environment. The camera system further includes a wavelength-selective reflective element designed to reflect the light of a first wavelength and to transmit the light of a second wavelength. The camera system further includes a controller comprising instructions executable to control the camera system to, in a first time period, activate the first modulatable laser source and deactivate the second modulatable laser source, and in a second time period, deactivate the first modulatable laser source and activate the second modulatable laser source. The camera system further includes a photosensor for receiving the light outputted by the first and second modulatable laser sources.

### BACKGROUND

Camera systems employ sensors and various imaging optics to capture information from the environment. The sensors generate signals in response to incident light photons. The signals can be interpreted to provide information in the desired format—e.g., an image. Different imaging techniques exist for different applications. For example, a camera system may employ a passive or an active imaging technique. Passive imaging techniques typically include the integration of accumulated light photons from external light sources incident on the sensors over a period of time—i.e., the exposure period. On the other hand, active imaging techniques provide their own source of light or illumination. One active imaging technique involves the use of time-of-flight (ToF) imaging optics to determine distances between the camera and the environment for a multiplicity of points. ToF utilizes a light source to project a light signal onto a target. In direct ToF (dToF), the light signal is reflected back onto a sensor of the camera system, and the round trip time is measured to determine the distance between the camera system and the target. In indirect ToF (iToF), the distance is calculated based on the phase shift between the projected and the reflected light.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples related to operating indirect time-of-flight cameras in multiple optical channels are provided. In one aspect, an indirect time-of-flight camera system includes first and second modulatable laser sources for illuminating a target environment, where the first modulatable laser source outputs light of a first wavelength and the second modulatable laser source outputs light of a second wavelength. The camera system further includes a wavelength-selective reflective element designed to reflect the light of the first wavelength and to transmit the light of the second wavelength. The camera system further includes a controller comprising instructions executable to control the camera system to, in a first time period, activate the first modulatable laser source and deactivate the second modulatable laser source, and in a second time period, deactivate the first modulatable laser source and activate the second modulatable laser source. The camera system further includes a photosensor for receiving the light of the first wavelength during the first time period and for receiving the light of the second wavelength during the second time period.

### BRIEF DESCRIPTION OF THE DRAWINGS

FIG. 1A shows a diagram schematically illustrating operation of an example camera system with two optical channels in accordance with an implementation of the present disclosure.

FIG. 1B shows a graph illustrating a transmission/reflection spectrum of an example wavelength-selective reflective element in accordance with an implementation of the present disclosure.

FIG. 2A shows a diagram schematically illustrating operation of an example camera system with three optical channels in accordance with an implementation of the present disclosure.

FIGS. 2B and 2C show graphs illustrating transmission/reflection spectra of example wavelength-selective reflective elements in an example camera system with three optical channels in accordance with an implementation of the present disclosure.

FIG. 3 shows a diagram schematically illustrating operation of an example camera system with two optical channels operating with different, overlapping field-of-views in accordance with an implementation of the present disclosure.

FIG. 4 shows a diagram schematically illustrating operation of an example camera system with two optical channels operating with field-of-views in different directions in accordance with an implementation of the present disclosure.

FIG. 5 shows a diagram schematically illustrating operation of an example camera system with two optical channels operating with field-of-views in opposite directions in accordance with an implementation of the present disclosure.

FIG. 6 shows a diagram schematically illustrating operation of an example camera system with three optical channels operating with field-of-views in different directions in accordance with an implementation of the present disclosure.

FIG. 7 shows a diagram schematically illustrating operation of an example camera system with two optical channels implemented using a switchable reflective element in accordance with an implementation of the present disclosure.

FIG. 8 shows a diagram schematically illustrating operation of an example camera system with three optical channels implemented using two switchable reflective components in accordance with an implementation of the present disclosure.

FIG. 9 shows a diagram schematically illustrating operation of an example camera system with two optical channels operating with field-of-views in different directions implemented using a switchable reflective element in accordance with an implementation of the present disclosure.

FIG. 10 shows a diagram schematically illustrating operation of an example camera system with a switchable reflective element for switching the illumination direction of a single laser source in accordance with an implementation of the present disclosure.

FIG. 11 shows a diagram schematically illustrating operation of an example camera system with two optical channels operating with time-of-flight imaging and intensity imaging, respectively, in accordance with an implementation of the present disclosure.

FIG. 12 shows a flow diagram illustrating an example method for operating a camera system with multiple optical channels in accordance with an implementation of the present disclosure.

FIG. 13 schematically shows a non-limiting embodiment of a computing system that can enact one or more of the methods and processes described above.

### DETAILED DESCRIPTION

Camera systems have constraints that are dependent upon the hardware and imaging techniques utilized. In designing a camera system for a specific application, choices in hardware and/or imaging techniques and their associated tradeoffs are among the factors considered. For example, camera systems implemented for applications in low-light environments may employ systems with increased exposure times. However, such design has accompanying tradeoffs in reduced frame rates and/or dynamic range. Another example includes camera systems implemented for augmented/virtual/mixed reality (AR/VR/MR) applications. Such systems may have cost, size, and power constraints that may result in hardware choices with more limited color range or limited field-of-views (FoVs). In general, performance shortcomings in many applications can be compensated with additional or more expensive hardware. However, the added cost and size to the system may be unacceptable for certain applications, such as the AR/VR/MR applications described above.

In view of the observations above, the present disclosure describes example camera systems and accompanying methods for implementing a camera with multiple optical channels. Camera systems with multiple optical channels can be implemented to combine different functionalities, such as increased FoV, using limited hardware, making such systems suitable for low cost, small form factor applications. For example, such camera systems may be implemented in wearable computer-capable glasses, helmet-mounted displays (HMDs), heads-up displays (HUDs), etc. for various AR/VR/MR applications. In many implementations, the camera system is an active imaging system, employing at least one sensor and at least one light source operating in a plurality of optical channels. In further implementations, the camera system employs a single sensor for operating with the plurality of optical channels. In an active imaging system, the light sources serve to illuminate a target environment. Backscatter-reflected light from the illuminated target environment that is incident on the sensor or sensors inform the camera system on various aspects of the environment. For example, by measuring the round-trip time of the light, the distance between the camera and the target environment can be calculated. As more points in the target environment are calculated, a depth map can be generated.

Camera systems with multiple optical channels can be implemented using various mechanisms. In some implementations, the camera system includes multiple lights sources that are operated in a serial manner. By serially activating the multiple light sources, a time-multiplexed approach can be implemented to enable multiple optical channels using a single sensor. For example, a camera system can be implemented with a single sensor, two light sources, and at least one wavelength-selective reflective element to implement two optical channels. The two light sources can alternate in their activations such that the single sensor receives information from a single light source at any given time point. In some implementations, the camera system includes at least one electrically switchable reflective element and at least one light source for enabling multiple optical channels. In such cases, the switching of the electrically switchable reflective element(s) enables improved performance or improved flexibility (e.g., operation at a single wavelength). Various types of dynamic reflective elements may be implemented depending on the application.

The light sources and their associated optical channels can be designed independently for various applications. For example, a camera system with two optical channels can be implemented with a sensor and two light sources that operate with different FoVs. Activation of the two light sources can alternate to enable the camera system to operate with two optical channels. Such configurations provide faster channel switching times compared to approaches utilizing dynamic reflective elements. For example, in systems utilizing electrically switchable mirrors, the typical switching time of such elements are several orders higher than the switching time of certain light sources such as laser diodes. Depending on the type of light sources that is utilized, the switching time can be on the order of a few nanoseconds. The sensor can time-multiplex incoming light photons based on the timing of the switching of the light sources. As a result, the camera system captures information that is a combination of the different FoVs in which the light sources are operating. Accordingly, the FoV of the camera system as a whole is increased at the expense of frame rate. To implement these operations and switching states, the camera system can include a controller for controlling the various components. For example, the controller can activate and deactivate the light sources at appropriate time periods to implement a multiplexed multi-optical channel system.

In the presence of broadband ambient light, when the light source for a particular field-of-view is energized, ambient light within the passband of the optical system for other fields of view can still reach the iToF sensor. However, in the case of time of flight or other systems where the light is modulated, the sensor responds differently to active illumination (which is temporally modulated at the same frequency as the sensor—i.e., homodyne operation) and the ambient light (which is temporally substantially static within an integration time). The active illumination forms an active brightness or depth image on the sensor, and the ambient light from any channel is discarded by the iToF sensor. Although ambient light is rejected by the sensor, noise from the ambient light is not rejected by the sensor. In some embodiments, ambient light from the optical systems of alternate fields of view is suppressed using electrically switchable filters. In other examples, such electrically switchable filters are not used. While noise levels may be higher in examples without electrically switchable filters, optical performance still may be acceptable. Further, the omission of electrically switchable filters may improve system switching speeds (as light sources have faster switching speeds than electrically switchable filters) and also lower device cost relative to the use of electrically switchable filters. These and other camera systems utilizing multiple optical channels are described below in further detail.

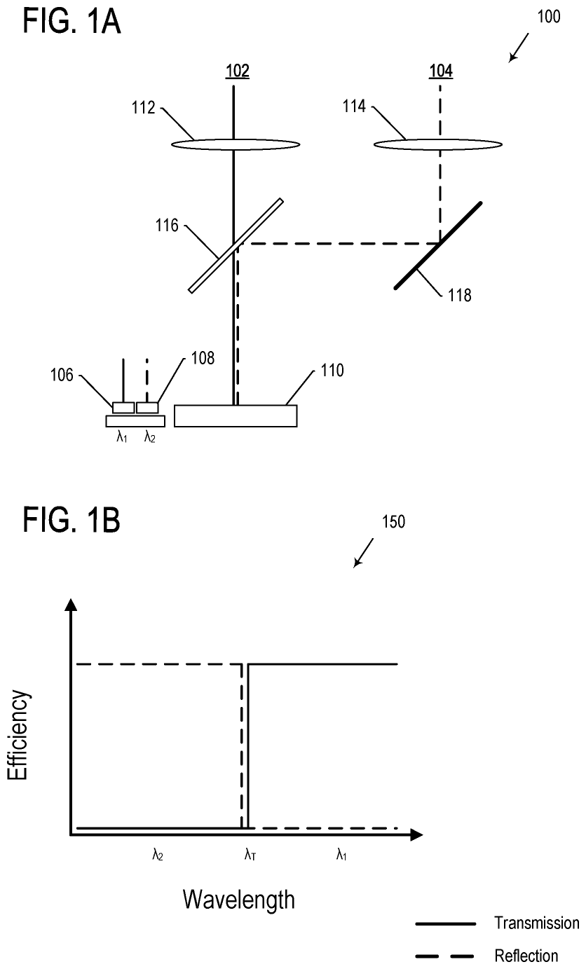

FIG. 1A shows a diagram schematically illustrating operation of an example camera system 100 with two optical channels 102, 104 in accordance with an implementation of the present disclosure. As depicted, the camera system 100 is an active imaging system utilizing first and second laser sources 106, 108 for illuminating a target environment. The two laser sources 106, 108 can be modulatable laser sources for outputting modulated light. Advantages in using a laser source include operating in a narrow wavelength band, which can simplify the implementation of other optical components within the system. Another advantage includes the capability of switching between light sources quickly (e.g., switching times on the order of nanoseconds). For example, implementation of wavelength-selective elements is simpler when operating in a narrow wavelength band. Other types of light sources may be implemented in other examples. For example, a light-emitting diode (LED) also may be used as an illuminating light source for outputting modulated light, as LEDs also have sufficiently high switching speeds. The laser sources 106, 108 output light of wavelengths λ₁ and λ₂, respectively. Wavelengths λ₁ and λ₂ are different from each other (e.g., λ₁<λ₂). The laser sources can be implemented to output light of specific wavelengths depending on the application. In some implementations, the laser sources output non-visible light, such as near infrared light or shortwave infrared light. Operating in certain wavelength bands can be advantageous. For example, operating in the shortwave infrared wavelength band enables the camera system to perform with low ambient noise.

The camera system 100 further includes a sensor 110 for detecting incident light. Different types of photosensors can be implemented depending on the application. The sensor 110 is configured to distinguish between ambient light and modulated light. For example, the sensor 112 can be an iToF sensor, which naturally reject ambient light. In some implementations, the sensor can be a charged coupled device (CCD) or a complementary metal-oxide semiconductor (CMOS) sensor configured to distinguish ambient light and modulated light. However, such sensors can produce superimposed ghost images if certain configurations of the implemented light sources and optical elements are incompatible. For example, in camera systems utilizing switchable optical element with high efficiencies, such CCD and CMOS sensors can be implemented without superimposed ghost images. In some implementations, the sensor 110 is designed to have high sensitivity to light of wavelengths that are outputted by the laser sources 106, 108. The camera system 100 is designed such that backscatter-reflected light from the illuminated target environment is collected and directed towards the sensor 110. For example, during operation, the two laser sources 106, 108 output light to illuminate a target environment. Backscatter-reflected light from the illuminated environment is collected through first and second lenses 112, 114 and is directed towards a wavelength-selective reflective element 116. In the depicted camera system 100, the two laser sources 106, 108 output light in a similar direction. In such cases, backscatter-reflected light from the second laser source 108 can be directed towards the wavelength-reflective element 116 using a reflective element 118. The wavelength-selective element 116 can be implemented using various optical components. For example, the wavelength-selective reflective element 116 can be implemented using a dichroic mirror, reflection grating, etc. The reflective element 118 can also be implemented using various optical components, such as a mirror, a reflection grating, etc. In some implementations, the reflective element 118 includes a wavelength-selective reflective element. The operating band of the wavelength-selective reflective element is selected to reduce ambient light from being directed towards the sensor 110.

Backscatter-reflected light from the two laser sources 106, 108 is incident on the wavelength-selective reflective element 116 at different angles. In the example camera system 100, the wavelength-selective reflective element 116 has a transmission/reflection spectrum such that light of wavelength λ₁ is transmitted while light of wavelength λ₂ is reflected. Accordingly, backscatter-reflected light from the first laser source 106 is transmitted through the wavelength-selective reflective element 116, and backscatter-reflected light from the second laser source 108 is reflected off the wavelength-selective element 116.

FIG. 1B shows a graph 150 illustrating a transmission/reflection spectrum of an example wavelength-selective reflective element in accordance with an implementation of the present disclosure. Using the camera system 100 of FIG. 1A as an example, graph 150 can represent the transmission/reflection spectrum of the wavelength-selective element 116. The transmission spectrum shows high efficiency for wavelength λ₁ and low efficiency for wavelength λ₂. The reflection spectrum shows high efficiency for wavelength λ₂ and low efficiency for wavelength λ₁. Between wavelengths λ₁ and λ₂ is a wavelength λ_{T} where a sharp transition in the reflection/transmission spectrum occurs.

As can readily be appreciated, other configurations can be implemented to redirect backscatter-reflected light from the first and second laser sources 106, 108 towards the sensor 110. For example, instead of a wavelength-selective element 116, the camera system 100 can utilize a partial mirror. The partial mirror can be partially reflective and partially transmissive (e.g., 50% reflective and 50% transmissive). In such cases, the operating wavelength band of the partial mirror is arbitrary, as the partial mirror is not wavelength-sensitive. Additionally, the wavelength of the light outputted by the laser sources 106, 108 is also arbitrary. For example, the laser sources 106, 108 can output light of the same wavelengths.

Referring back to FIG. 1A, the various optical components are oriented such that the transmitted light from the first laser source 106 and the reflected light from the second laser source 108 are directed towards the sensor 110. To provide meaningful information, the first and second laser sources 106, 108 are activated in an alternating pattern. The first and second laser sources 106, 108 can be activated and deactivated using a controller. Different switching configurations of the first and second laser sources 106, 108 allow the setting of the desired optical channel. For example, the first laser source 106 can be activated for a first time period and deactivated for a sequential second time period. The second laser source 108 can be deactivated for the first time period and activated for the sequential second time period. In such cases, the first optical channel 102 is active during the first time period, and the second optical channel 104 is active during the second time period. Accordingly, only one optical channel is in operation at any given time point. Time-multiplexing can be performed to collect information from both optical channels using a single sensor.

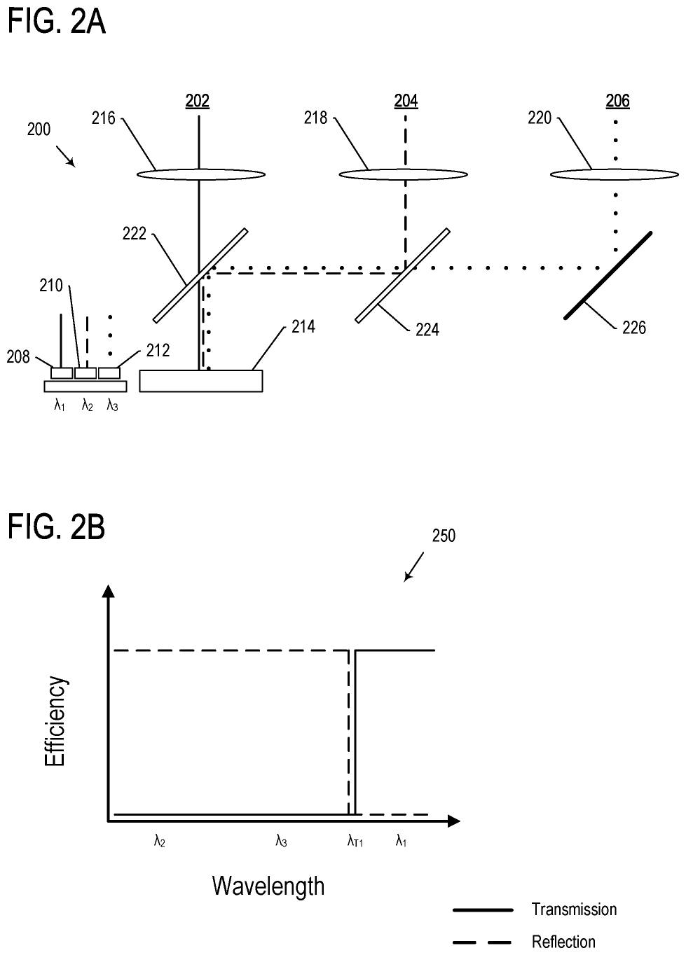

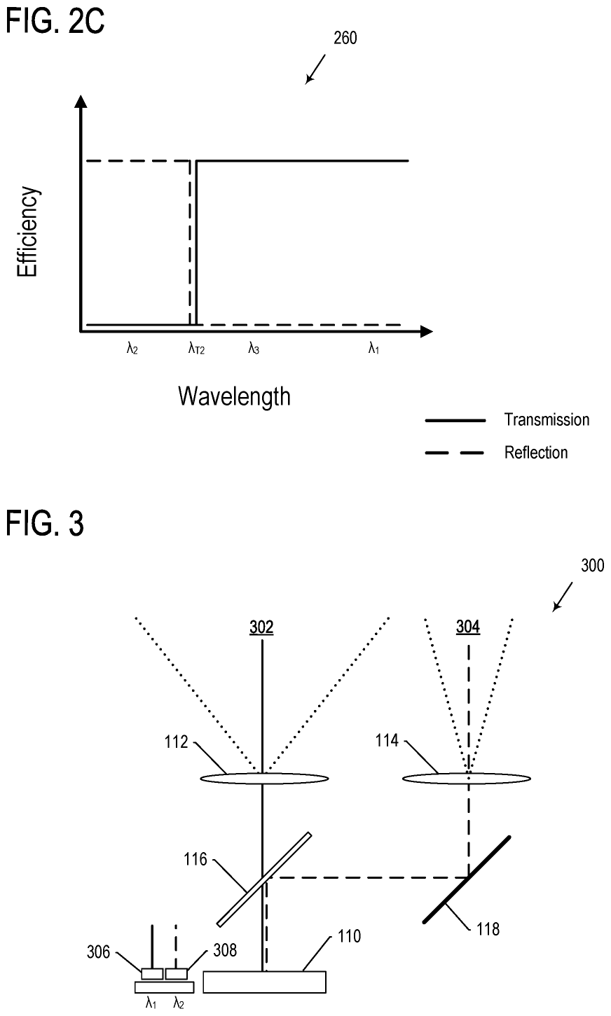

The example camera system 100 of FIG. 1A utilizes two light sources for implementing two optical channels. Such a system can be extrapolated to implement higher numbers of optical channels. FIG. 2A shows a diagram schematically illustrating operation of an example camera system 200 with three optical channels 202-206 in accordance with an implementation of the present disclosure. As depicted, the camera system 200 includes three laser sources 208-212 for implementing the three optical channels 202-206, respectively. The three laser sources 208-212 are implemented to output light of wavelengths λ₁, λ₂, and λ₃, respectively, to illuminate a target environment. The three laser sources 208-212 can be modulatable laser sources for outputting modulated light. In the example camera system 200, the three laser sources 208-212 output light in a similar direction. The camera system 200 further includes a sensor 214 for detecting incident light. Similar to the camera system 100 of FIG. 1A, the switching of the three laser sources 208-212 can be implemented such that, for any given time point, one laser source is activated and the sensor 214 receives backscatter-reflected light from said laser source. For example, a controller can be implemented to activate the first laser source 208 and deactivate the second and third laser sources 210, 212 during a first time period. The controller can activate the second laser source 210 and deactivate the first and third laser sources 208, 212 during a second time period. The controller can activate the third laser source 212 and deactivate the first and second laser sources 208, 210 during a third time period. The camera system 200 further includes three lenses 216-220, first and second wavelength-selective elements 222, 224, and a reflective element 226 for redirecting backscatter-reflected light towards the sensor 214.

As oriented, the light path of the first optical channel 202 includes travelling through the first lens 216 and transmitting through the first wavelength-selective reflective element 222 towards the sensor 214. The light path of the second optical channel 204 includes traveling through the second lens 218, reflecting off the second wavelength-selective reflective element 224, and reflecting off the first wavelength-selective reflective element 222 towards the sensor 214. The light path of the third optical channel 206 includes traveling through the third lens 220, reflecting off the reflective element 226, transmitting through the second wavelength-selective reflective element 224, and reflecting off the first wavelength-selective reflective element 222 towards the sensor 214. Accordingly, the first wavelength-selective reflective element 222 is designed to at least reflect light of wavelengths λ₂ and λ₃ and to at least transmit light of wavelength λ₁. The second wavelength-selective reflective element 224 is designed to at least reflect light of wavelength λ₂ and to at least transmit light of wavelength λ₃. In some examples, additional components may be used such that the light path of the third optical channel 206 does not pass through the second wavelength-selective reflective element 224 (i.e., light travelling through the third lens 220 is reflected off the reflective element 226 towards the first wavelength-selective reflective element 222). In such cases, the transmissive property of the second wavelength-selective reflective element 224 for wavelength λ₃ is irrelevant.

FIGS. 2B and 2C show graphs 250, 260 illustrating transmission/reflection spectra of example wavelength-selective reflective elements in a camera system with three optical channels in accordance with an implementation of the present disclosure. Using the camera system 200 of FIG. 2A as an example, graph 250 can represent the transmission/reflection spectrum of the first wavelength-selective element 222, and graph 260 can represent the transmission/reflection spectrum of the second wavelength-selective element 224. The transmission spectrum for the first wavelength-selective element 222 shows high efficiency for wavelength λ₁ and low efficiency for wavelengths λ₂, λ₃. The reflection spectrum for the first wavelength-selective element 222 shows high efficiency for wavelengths λ₂, λ₃ and low efficiency for wavelength λ₁. Between wavelengths λ₃ and λ₁ is a wavelength λ_{T1} where a sharp transition in the reflection/transmission spectrum occurs. The transmission spectrum for the first wavelength-selective element 224 shows high efficiency for wavelengths λ₁, λ₃ and low efficiency for wavelength λ₂. The reflection spectrum for the first wavelength-selective element 224 shows high efficiency for wavelength λ₂ and low efficiency for wavelengths λ₁, λ₃. Between wavelengths λ₂ and λ₃ is a wavelength k n where a sharp transition in the reflection/transmission spectrum occurs. In the example of FIGS. 2A-2C, wavelength λ₂<λ₃<λ₁.

Camera systems with multiple optical channels enable the combination of multiple functionalities into a single sensor system. For example, a camera system can be implemented with multiple optical channels that provide different FoV information. In some implementations, the multiple optical channels operate at different ranges. FIG. 3 shows a diagram schematically illustrating operation of an example camera system 300 with two optical channels 302, 304 operating with different, overlapping field-of-views in accordance with an implementation of the present disclosure. Camera system 300 can be implemented similarly as the example camera system 100 of FIG. 1A. The two optical channels 302, 304 are shown operating in the same direction. The two optical channels 302, 304 operate with different, overlapping FoVs. Various configurations can be implemented depending on the application. For example, the first optical channel 302 and associated laser source 306 can be implemented to operate in a first FoV. The second optical channel 304 and associated laser source 308 can be optimized and implemented to operate in a second FoV narrower than the first FoV but at longer distances.

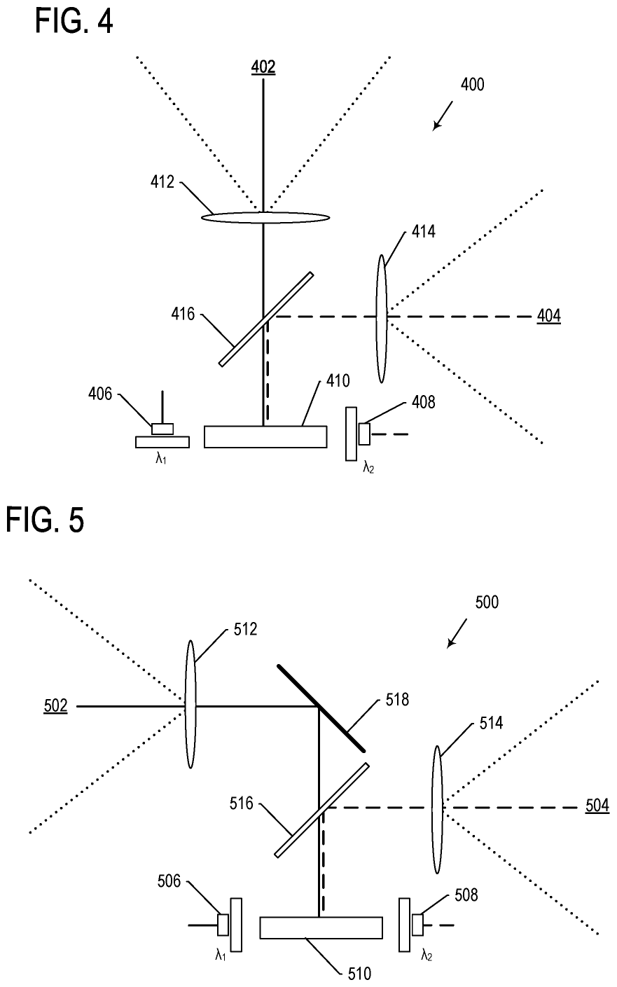

Another application of multiple optical channels includes combining FoVs of multiple optical channels into a larger FoV. FIG. 4 shows a diagram schematically illustrating operation of an example camera system 400 with two optical channels 402, 404 operating with field-of-views in different directions in accordance with an implementation of the present disclosure. The camera system 400 includes first and second laser sources 406, 408 oriented in different directions for implementing the two optical channels 402, 404, respectively. The two laser sources 406, 408 can be modulatable laser sources for outputting modulated light. The first and second laser sources 406, 408 are implemented to output light of wavelengths λ₁ and λ₂, respectively, to illuminate a target environment. In the depicted camera system 400, the two laser sources 406, 408 are oriented with an offset of 90 degrees. Other configurations can be implemented depending on the application. For example, optical channels operating with wider FoVs can be implemented with laser sources having different angular offsets. The first optical channel 402 and first laser source 406 operate with a first FoV. The second optical channel 404 and second laser source 408 are oriented to operate with a second FoV in a different direction than the first FoV. In some implementations, the first and second FoVs partially overlap with one another.

The camera system 400 further includes a sensor 410 for detecting incident light. Similar to the camera system 100 of FIG. 1A, the switching of the first and second laser sources 406, 408 can be implemented such that, for any given time point, one laser source is activated and the sensor 410 receives backscatter-reflected light from said laser source. The camera system 400 further includes first and second lenses 412, 414 and a wavelength-selective elements 416 for redirecting backscatter-reflected light towards the sensor 410.

The light path of the first optical channel 402 includes traveling through the first lens 412 and transmitting through the wavelength-selective reflective element 416 towards the sensor 410. The light path of the second optical channel 404 includes travelling through the second lens 414 and reflecting off the wavelength-selective reflective element 416 towards the sensor 410. Accordingly, the wavelength-selective reflective element 416 is designed to at least reflect light of wavelength λ₂ and to at least transmit light of wavelength λ₁.

The second laser source 408 can be oriented such that backscatter-reflected light traveling through the second lens 414 is directly incident on the wavelength-selective reflective element 412 (i.e., the second optical channel 404 can operate without a reflective element to redirect light towards the wavelength-selective reflective element 416). In other implementations, a reflective element is implemented to enable different orientations of the laser sources and, by extension, the FoVs. FIG. 5 shows a diagram schematically illustrating operation of an example camera system 500 with two optical channels 502, 504 operating with field-of-views in opposite directions in accordance with an implementation of the present disclosure. The camera system 500 includes first and second laser sources 506, 508 oriented in opposite directions for implementing the two optical channels 502, 504. Accordingly, the two optical channels 502, 504 operate with FoVs in opposite directions. As can readily be appreciated, the laser sources 506, 508 can be oriented in various configurations depending on the application. The two laser sources 506, 508 can be modulatable laser sources for outputting modulated light. The first and second laser sources 506, 508 are implemented to output light of wavelengths λ₁ and λ₂, respectively, to illuminate a target environment. The camera system 500 further includes a sensor 510 for detecting incident light. Similar to the camera system 100 of FIG. 1A, the switching of the first and second laser sources 506, 508 can be implemented such that, for any given time point, one laser source is activated and the sensor 510 receives backscatter-reflected light from said laser source. The camera system 500 further includes first and second lenses 512, 514, a wavelength-selective reflective element 516, and a reflective element 518 for redirecting backscatter-reflected light towards the sensor 510.

The light path of the first optical channel 502 includes travelling through the first lens 512, reflecting off the reflective element 518, and transmitting through the wavelength-selective reflective element 516 towards the sensor 510. The light path of the second optical channel 504 includes travelling through the second lens 514 and reflecting off the wavelength-selective reflective element 516 towards the sensor 510. Accordingly, the wavelength-selective reflective element 516 is designed to at least reflect light of wavelength λ₂ and to at least transmit light of wavelength λ₁.

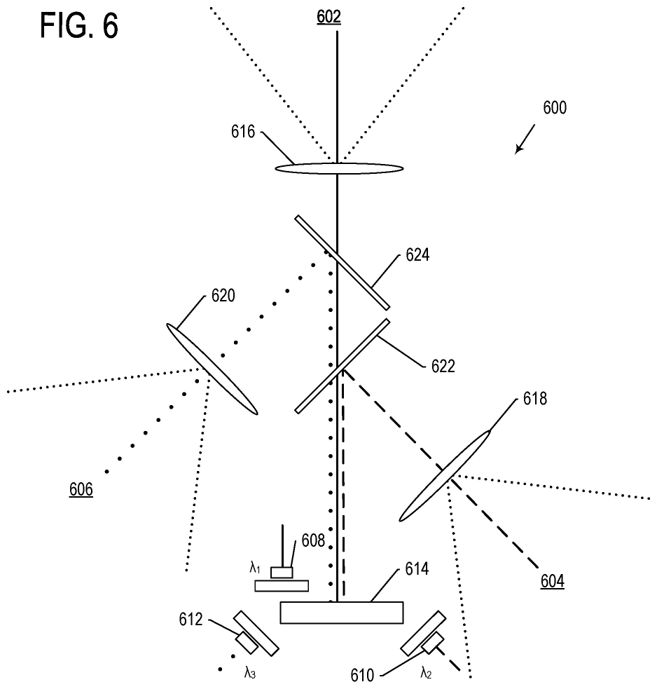

As described above with regards to example camera system 200 of FIG. 2A, camera systems in accordance with the present disclosure can be implemented with more than two optical channels. Similarly, camera systems operating with two optical channels with different FoVs, such as the camera system 500 described in FIG. 5, can be extrapolated to higher numbers of optical channels. FIG. 6 shows a diagram schematically illustrating operation of an example camera system 600 with three optical channels 602-606 operating with field-of-views in different directions in accordance with an implementation of the present disclosure. The camera system 600 includes three laser sources 608-612 oriented in different directions from one another. The three laser sources 608-612 can be modulatable laser sources for outputting modulated light. The three laser sources 608-612 are implemented to output light of wavelengths λ₁, λ₂, and λ₃, respectively, to illuminate a target environment. The camera system 600 further includes a sensor 614 for detecting incident light. Similar to the camera system 200 of FIG. 2A, the switching of the laser sources 608-612 can be implemented such that, for any given time point, one laser source is activated and the sensor 614 receives backscatter-reflected light from said laser source. The camera system 600 further includes three lenses 616-620 and first and second wavelength-selective elements 622, 624 for redirecting backscatter-reflected light towards the sensor 614.

The light path of the first optical channel 602 includes traveling through the first lens 616 and transmitting through the first and second wavelength-selective reflective elements 622, 624 towards the sensor 614. The light path of the second optical channel 604 includes traveling through the second lens 618 and reflecting off the first wavelength-selective reflective element 622 towards the sensor 620. The light path of the third optical channel 606 includes travelling through the third lens 620, reflecting off the second wavelength-selective reflective element 624, and transmitting through the first wavelength-selective reflective element 622 towards the sensor 614. Accordingly, the first wavelength-selective reflective element 622 is designed to at least reflect light of wavelength λ₂ and to at least transmit light of wavelengths λ₁ and λ₃. The second wavelength-selective reflective element 624 is designed to at least reflect light of wavelength λ₃ and to at least transmit light of wavelength λ₁.

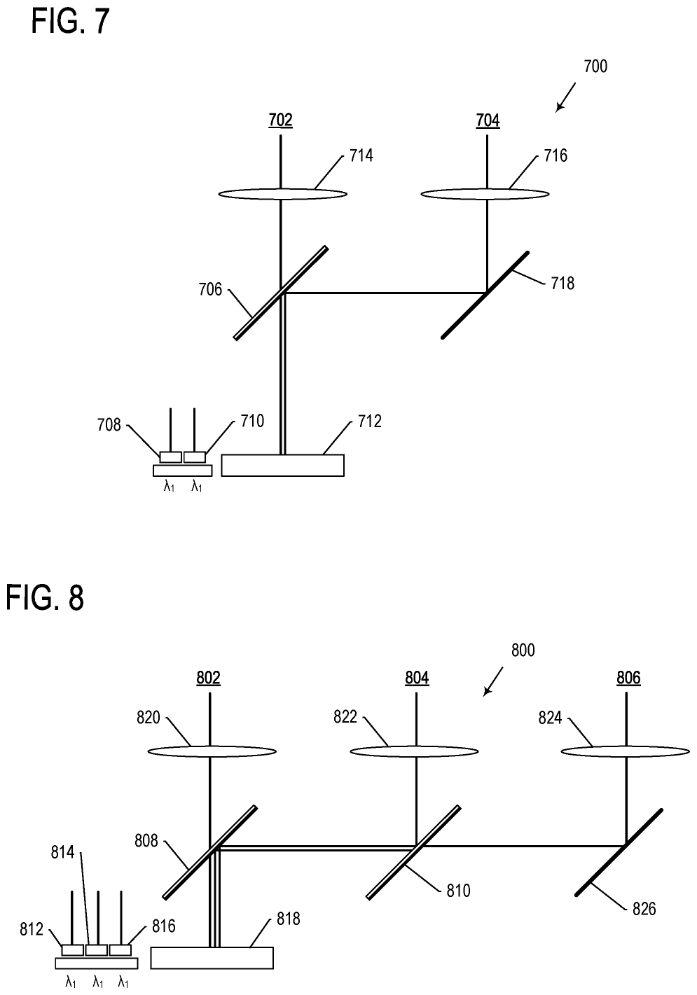

Example camera systems with multiple optical channels as described above are implemented with multiple illuminating light sources and static mechanisms such as wavelength-reflective selective elements and reflective elements. In other implementations, dynamic components are implemented to enable operation of multiple optical channels. FIG. 7 shows a diagram schematically illustrating operation of an example camera system 700 with two optical channels 702, 704 implemented using a switchable reflective element 706 in accordance with an implementation of the present disclosure. The switchable reflective element 706 can include electrically switchable components. In some implementations, the switchable reflective component includes a switchable mirror. In other implementations, the switchable reflective element 706 includes a switchable reflection grating, such as a volume Bragg grating formed using polymer-dispersed liquid crystals. Various types of volume holographic gratings can be implemented. In some embodiments, a switchable volume grating with helical structures having a varying pitch profile (e.g., a chirped grating) is implemented as a broadband switchable reflective element.

The camera system 700 further includes first and second laser sources 708, 710 for illuminating a target environment. The first and second laser sources 708, 710 can be modulatable laser sources for outputting modulated light. In some examples, when utilizing switchable reflective components for redirecting light in multiple optical channels, the illumination light can be of a same optical wavelength. In such examples, the camera system 700 can be designed to attenuate undesired light and ambient noise from FoVs of non-active optical channels. For example, the switchable reflective element 706 can be designed to have high efficiency (e.g., 80% or more) to reduce the amount of light from FoVs of non-active optical channels that is incident on the sensor 712. In other implementations, the two laser sources 708, 710 output light of different wavelengths. In such cases, the attenuation of undesired light from FoVs of non-active optical channels becomes less of an issue. The sensor 712 can be tuned to the two different laser sources 708, 710. Higher amounts of such attenuation of undesired light from FoVs of non-active optical channels will provide lower noise from the non-active optical channels. In some implementations, the switchable reflective element 706 is wavelength-selective. In such an example, the switchable reflective element 706 can be designed to at least partially transmit backscatter-reflected light from laser source 708 and to at least partially reflect backscatter-reflected light from laser source 710. In some implementations, a camera system with two optical channels is implemented with a single laser source in combination with a beamsplitter and various imaging optics to form the two optical channels. The camera system 700 further includes first and second lenses 714, 716 for collecting backscatter-reflected light, and a reflective element 718 for redirecting the backscatter-reflected light. In some implementations, the camera system 700 includes filters designed to block at least a portion of ambient light while transmitting light of wavelength λ₁.

The switchable reflective element 706 can be designed to at least partially reflect light of a specific wavelength range. For example, the switchable reflective element 706 can be designed to at least partially transmit at least light of wavelength λ₁ when in a first state and to at least partially reflect at least light of wavelength λ₁ when switched to a second state. In some implementations, the switchable reflective element 706 is designed to at least partially reflect a broadband of wavelengths when in the second state. As described above, the effect of attenuating light from non-active optical channels can depend on the configuration of the camera system 700. The attenuation of such light does not need to be complete in iToF systems. In implementations where the two laser sources 708, 710 provide light of different wavelengths, attenuation becomes less of an issue as the sensor can be respectively tuned to the two laser sources 708, 710. The switching of switchable reflective elements can be performed using a controller. Operation of the two optical channels 702, 704 can be determined by the setting of the switchable reflective element 706. When the switchable reflective element 706 is in the first state, the first optical channel 702 is active. When the switchable reflective element 706 is in the second state, the second optical channel 704 is active. The light path of the first optical channel 702 includes traveling through the first lens 714 and transmitting through the switchable reflective element 706 towards the sensor 712. The light path of the second optical channel 704 includes traveling through the second lens 716, reflecting off the reflective element 718, and reflecting off the switchable reflective element 706 towards the sensor 712.

Switchable reflective components can be utilized in camera systems with more than two optical channels. For example, a camera system with three optical channels can be implemented using two switchable reflective components. FIG. 8 shows a diagram schematically illustrating operation of an example camera system 800 with three optical channels 802-806 implemented using two switchable reflective components 808, 810 in accordance with an implementation of the present disclosure. The camera system 800 includes three laser sources 812-816 for illuminating a target environment. In the example camera system 800, the three laser sources 812-816 output light of a similar wavelength λ₁. In other implementations, the three laser sources 812-816 output light of different wavelengths. The camera system 800 further includes a sensor 818 for detecting incident light, three lenses 820-824 for collecting backscatter-reflected light, and a reflective element 826 for redirecting the backscatter-reflected light.

The switchable reflective elements 808, 810 can be designed to at least partially reflect light of a specific wavelength range. For example, the switchable reflective elements 808, 810 can be designed to at least partially transmit at least light of wavelength λ₁ when in a first state and to at least partially reflect at least light of wavelength λ₁ when switched to a second state. In some implementations, the switchable reflective elements 808, 810 are designed to at least partially reflect a broadband of wavelengths when in the second state. Operation of the three optical channels 802-806 can be determined by the settings of the two switchable reflective elements 808, 810. When the first switchable reflective element 808 is in the first state, the first optical channel 802 is active. When the first switchable reflective element 808 is in the second state and the second switchable reflective element 810 is in the second state, the second optical channel 804 is active. When the first switchable reflective element 808 is in the second state and the second switchable reflective element 810 is in the first state, the third optical channel 806 is active. The light path of the first optical channel 802 includes traveling through the first lens 820 and transmitting through first switchable reflective element 808 towards the sensor 818. The light path of the second optical channel 804 includes traveling through the second lens 822, reflecting off second switchable reflective element 810, and reflecting off the first switchable reflective element 808 towards the sensor 818. The light path of the third optical channel 806 includes traveling through the third lens 824, reflecting off the reflective element 826, transmitting through the second switchable reflective element 810, and reflecting off the first switchable reflective element 808 towards the sensor 818.

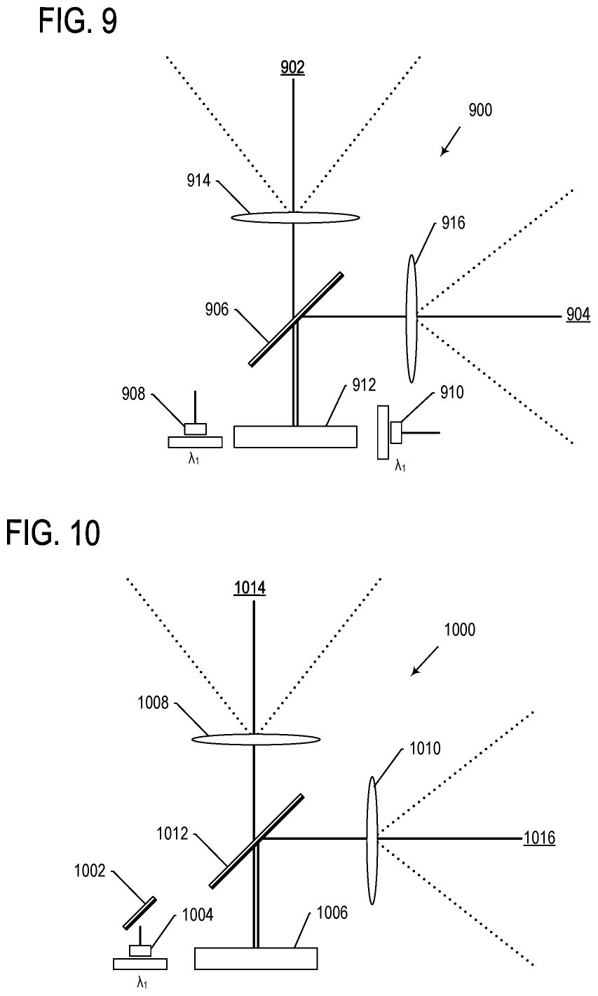

Switchable optical components can also be applied to camera systems implementing multiple optical channels operating with different FoVs. FIG. 9 shows a diagram schematically illustrating operation of an example camera system 900 with two optical channels 902, 904 operating with field-of-views in different directions implemented using a switchable reflective element 906 in accordance with an implementation of the present disclosure. The camera system 900 includes first and second laser sources 908, 910 oriented in different directions for implementing the two optical channels 902, 904, respectively. The two laser sources 908, 910 are oriented with an offset of 90 degrees. Other configurations can be implemented depending on the application. For example, optical channels operating with wider FoVs can be implemented with laser sources having larger angular offsets. In the example camera system 900, the two laser sources 908, 910 output light of a similar wavelength λ₁. In other implementations, the two laser sources 908, 910 output light of different wavelengths. The first optical channel 902 and first laser source 908 operate with a first FoV. The second optical channel 904 and second laser source 910 are oriented to operate with a second FoV in a different direction than the first FoV. In some implementations, the first and second FoVs partially overlap with one another. The camera system 900 further includes a sensor 912 for detecting incident light, first and second lenses 914, 916 for collecting backscatter-reflected light, and a reflective element 918 for redirecting the backscatter-reflected light.

The switchable reflective element 906 can be designed to at least partially reflect light of a specific wavelength range. For example, the switchable reflective element 906 can be designed to at least partially transmit at least light of wavelength λ₁ when in a first state and to at least partially reflect at least light of wavelength λ₁ when switched to a second state. In some implementations, the switchable reflective element 906 is designed to at least partially reflect a broadband of wavelengths when in the second state. Operation of the two optical channels 902, 904 can be determined by the setting of the switchable reflective element 906. When the switchable reflective element 906 is in the first state, the first optical channel 902 is active. When the switchable reflective element 906 is in the second state, the second optical channel 904 is active. The light path of the first optical channel 902 includes traveling through the first lens 914 and transmitting through the switchable reflective element 906 towards the sensor 912. The light path of the second optical channel 904 includes traveling through the second lens 916 and reflecting off the switchable reflective element 906 towards the sensor 912.

As described above, camera systems with multiple optical channels utilizing switchable reflective elements can be implemented using multiple laser sources designed to output light of the same or similar wavelength. Such systems can be implemented with a single laser source in combination with a switchable reflective element for redirecting output light from the laser source. FIG. 10 shows a diagram schematically illustrating operation of an example camera system 1000 with a switchable reflective element 1002 for switching the illumination direction of a single laser source 1004 in accordance with an implementation of the present disclosure. The laser source 1004 is designed to output light of wavelength λ₁ towards the switchable reflective element 1002. The camera system 1000 further includes a sensor 1006, first and second lenses 1008, 1010 for collecting backscatter-reflected light, and a second switchable reflective element 1012. The two switchable reflective elements 1002, 1012 can be designed to at least partially transmit at least light of wavelength λ₁ when in a first state and to reflect at least light of wavelength λ₁ when switched to a second state. In some implementations, the two switchable reflective elements 1002, 1012 are designed to at least partially reflect a broadband of wavelengths when in the second state.

The states of the switchable reflective element 1002 determines the illumination direction of the laser source 1004 and, consequently, the active optical channel. For example, when the switchable reflective element 1002 is in the first state, light from the laser source 1004 is transmitted through the switchable reflective element 1002 to illuminate the target environment in a first direction. In such a setting, a first optical channel 1014 is active with a first FoV and a light path that includes travelling through the first lens 1008 towards the second switchable reflective element 1012. If the second switchable reflective element 1012 is in the first state, the light is transmitted through the second switchable reflective element 1012 towards the sensor 1006. When switchable reflective element 1002 is in the second state, light from the laser source 1004 is reflected off the switchable reflective element 1002 to illuminate the target environment in a second direction different from the first direction. A second optical channel 1016 is active with a second FoV different from the first FoV. The light path of the second optical channel 1016 includes travelling through the second lens 1010 towards the second switchable reflective element 1012. If the second switchable reflective element 1012 is in the second state, the light is reflected off the second switchable reflective element 1012 towards the sensor 1006. As can readily be appreciated, the camera system 1000 can be controlled to synchronize the switching of the states of the two switchable reflective elements 1002, 1012. For example, a controller can be implemented to switch the two switchable reflective elements 1002, 1012 to their first states during a first period of time and to their second states during a second period of time.

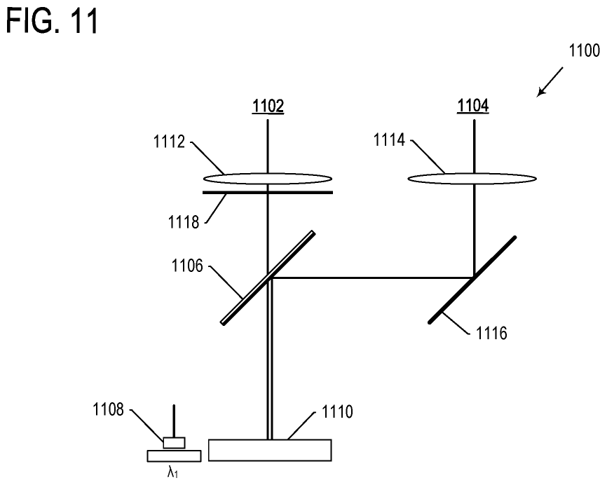

Camera systems operating in multiple optical channels can be implemented in various configurations through the use of different hardware and optical components. In some implementations, the camera system is implemented to operate in multiple optical channels that utilize different imaging techniques. FIG. 11 shows a diagram schematically illustrating operation of an example camera system 1100 with two optical channels 1102, 1104 operating with time-of-flight imaging and visible imaging, respectively, in accordance with an implementation of the present disclosure. The camera system 1100 includes a switchable reflective element 1106 for switching between the two optical channels 1102, 1104. The first optical channel 1102 operates using a time-of-flight imaging technique. As such, the camera system 1100 includes a laser source 1108 for outputting light of wavelength λ₁ to illuminate the environment. The camera system 1100 further includes a sensor 1110 for detecting incident light, a first lens 1112 for collecting backscatter-reflected light, a second lens 1114 for collecting external light, and a reflective element 1116 for redirecting the collected external light.

The switchable reflective element 1106 can be designed to at least partially transmit at light, including light of wavelength λ₁, when in a first state and to at least partially reflect at light, including light of wavelength λ₁, when switched to a second state. The switchable reflective element 1106 can be designed to at least partially transmit and at least partially reflect a broadband of wavelengths. For example, the switchable reflective element 1106 can be designed to, when in the second state, reflect external light in the second optical channel 1104, which includes visible light.

Operation of the two optical channels 1102, 1104 can be determined by the setting of the switchable reflective element 1106. When the switchable reflective element 1106 is in the first state, backscatter-reflected light from the illuminated environment is collected through the first lens 1112 and transmitted through the switchable reflective element 1106 towards the sensor 1110. The camera system 1100 includes a bandpass filter 1118 for filtering out ambient light. Several types of bandpass filters can be implemented depending on the specific configuration of the camera system. For example, wavelength λ₁ can include a wavelength in the shortwave infrared regime. In such cases, a bandpass filter designed to pass light within the shortwave infrared bandwidth can be implemented within the appropriate light path to filter out ambient light. For example, a near-infrared bandpass filter can be implemented.

When the switchable reflective element 1106 is in the second state, the second optical channel 1104 is active. In the example camera system 1100, the second optical channel 1104 operates using a visible imaging technique. The sensor 1110 integrates the amount of incident photons over an exposure period to capture an image. As such, the switchable reflective element 1106 can be designed to be a broadband reflective element to reflect incident visible light. The light path of the second optical channel 1104 includes travelling through the second lens 1114, reflecting off the reflective element 1116, and reflecting off switchable reflective element 1106 towards the sensor 1110.

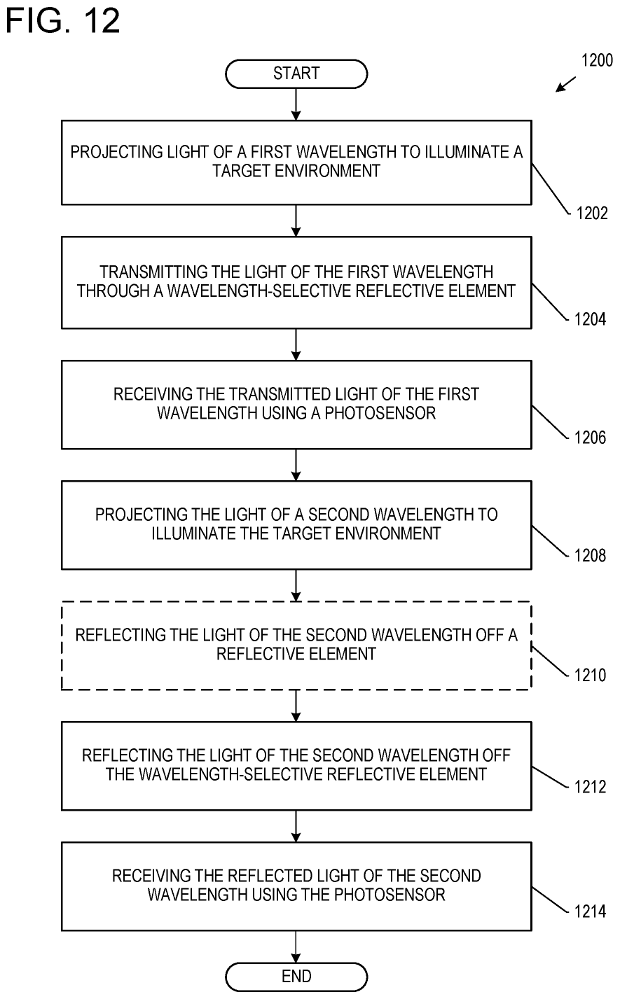

FIG. 12 shows a flow diagram illustrating an example method 1200 for operating a camera system with multiple optical channels in accordance with an implementation of the present disclosure. At step 1202, the method 1200 includes projecting light of a first wavelength to illuminate a target environment. In some implementations, the projected light is modulated light. The light of the first wavelength can illuminate the target environment over a first FoV. The light can be projected using various light sources. For example, the light source can include a modulatable laser source or a modulatable LED for outputting modulated light. In some applications, laser sources are advantageous due to their narrow band operation. The light sources can project light of various wavelengths. In some implementations, the light of the first wavelength is non-visible light. For example, the light of the first wavelength may be near infrared light or shortwave infrared light.

At step 1204, the method 1200 includes transmitting the light of the first wavelength through a first wavelength-selective reflective element. From the illuminated target environment, backscattering can occur. The backscatter-reflected light can be collected through a first lens of the camera system and directed towards the first wavelength-selective reflective element. The wavelength-selective element can be designed to have a high transmission efficiency for light of the first wavelength. The wavelength-selective reflective element can be implemented using a dichroic mirror, reflection grating, etc.

At step 1206, the method 1200 includes receiving the transmitted light of the first wavelength using a photosensor. The photosensor may comprise an iToF sensor. An iToF sensor may be used for many different use cases. For example, an iToF sensor may be used when reflective element 116 of FIG. 1 comprises a statistic partial mirror, with loss of approximately 50% of signal. An iToF sensor also may be used for a multiple wavelength case in which reflective element 116 is a static mirror, with substantially no loss of signal. An iToF sensor also may be used with “perfect” or imperfect switchable reflectors, with lasers of a same wavelength or different wavelengths. The photosensor also may comprise a CCD or CMOS image sensor in examples when a “perfect” switchable reflective element is used. Imperfections in the switchable reflective element that allow some light in an “off” channel to reach the photosensor may produce superimposed images that are visible as ghosting. Likewise, the use of a CCD or CMOS image sensor with static reflective elements also may lead to superimposed images.

At step 1208, the method includes 1200 projecting light of a second wavelength to illuminate the target environment. The light of the second wavelength can be projected to illuminate the target environment over a second FoV different from the first FoV. The light of the second wavelength can also be projected to illuminate the target environment at a longer distance than the projection of the light of the first wavelength. For example, the light of the second wavelength can be projected to illuminate the target environment over a second FoV that is narrower than the first FoV. Operating in a narrower FoV can allow the light source projecting the light of the second wavelength to operate at longer distances than if it had operated in the same FoV as the first FoV. The light of the second wavelength can be projected using various light sources, similar to the projection of the light of the first wavelength but with different wavelengths.

At step 1210, the method 1200 optionally includes using a reflective element to reflect backscatter-reflected light of the second wavelength. Depending on the orientations of the light sources used to illuminate the target environment, a reflective element may be used to redirect backscatter-reflected light towards the wavelength-selective reflective element. The reflective element can be implemented using various optical components, such as a mirror, a reflection grating, etc. In some implementations, the reflective element includes a wavelength-selective reflective element.

At step 1212, the method 1200 includes reflecting the light of the second wavelength off the wavelength-selective reflective element. The light of the second wavelength can include backscatter-reflected light can be collected through a second lens of the camera system. The wavelength-selective element can be designed to have a high reflective efficiency for light of the second wavelength.

At step 1214, the method 1200 includes receiving the reflected light of the second wavelength using the photosensor. By receiving both light of first and second wavelengths, the camera system can operate with two optical channels. The light sources projecting the light of first and second wavelengths can switch on and off in an alternating manner to implement a time-multiplexing scheme that enables the camera system to combine information from both optical channels. High numbers of optical channels can be implemented depending on the application. In some implementations, the method 1200 includes projecting light of a third wavelength to illuminate the target environment, transmitting the light of the third wavelength through a second wavelength-selective reflective element, reflecting the light of the third wavelength off the first wavelength-selective reflective element, and receiving the reflected light of the third wavelength using the photosensor.

In some embodiments, the methods and processes described herein may be tied to a computing system of one or more computing devices. In particular, such methods and processes may be implemented as a computer-application program or service, an application-programming interface (API), a library, and/or other computer-program product.

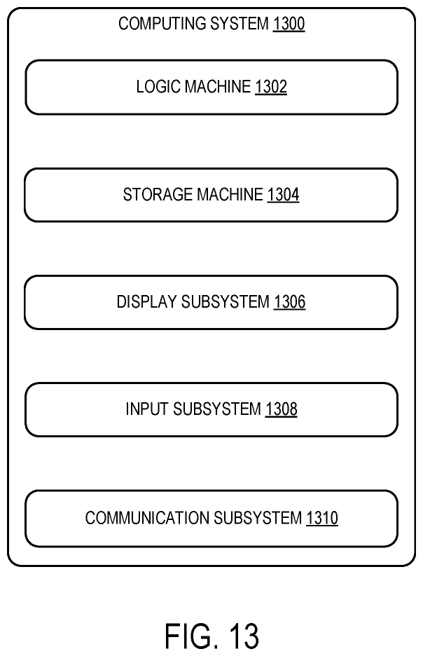

FIG. 13 schematically shows a non-limiting embodiment of a computing system 1300 that can enact one or more of the methods and processes described above. For example, the computing system 1300 can be implemented as a controller for controlling various components with a camera system. The computing system 1300 can be implemented to control operation and the switching of states and activation of the sensor(s), light source(s), and/or switchable optical component(s). Computing system 1300 is shown in simplified form. Computing system 1300 may take the form of one or more personal computers, server computers, tablet computers, home-entertainment computers, network computing devices, gaming devices, mobile computing devices, mobile communication devices (e.g., smart phone), and/or other computing devices.

Computing system 1300 includes a logic machine 1302 and a storage machine 1304. Computing system 1300 may optionally include a display subsystem 1306, input subsystem 1308, communication subsystem 1310, and/or other components not shown in FIG. 13.

Logic machine 1302 includes one or more physical devices configured to execute instructions. For example, the logic machine 1302 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 1302 may include one or more processors configured to execute software instructions. Additionally or alternatively, the logic machine 1302 may include one or more hardware or firmware logic machines configured to execute hardware or firmware instructions. Processors of the logic machine 1302 may be single-core or multi-core, and the instructions executed thereon may be configured for sequential, parallel, and/or distributed processing. Individual components of the logic machine 1302 optionally may be distributed among two or more separate devices, which may be remotely located and/or configured for coordinated processing. Aspects of the logic machine 1302 may be virtualized and executed by remotely accessible, networked computing devices configured in a cloud-computing configuration.

Storage machine 1304 includes one or more physical devices configured to hold instructions executable by the logic machine to implement the methods and processes described herein. When such methods and processes are implemented, the state of storage machine 1304 may be transformed—e.g., to hold different data.

Storage machine 1304 may include removable and/or built-in devices. Storage machine 1304 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1304 may include volatile, nonvolatile, dynamic, static, read/write, read-only, random-access, sequential-access, location-addressable, file-addressable, and/or content-addressable devices.

It will be appreciated that storage machine 1304 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1302 and storage machine 1304 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1300 implemented to perform a particular function. In some cases, a module, program, or engine may be instantiated via logic machine 1302 executing instructions held by storage machine 1304 It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1308 may be used to present a visual representation of data held by storage machine 1304. This visual representation may take the form of a graphical user interface (GUI). As the herein described methods and processes change the data held by the storage machine, and thus transform the state of the storage machine, the state of display subsystem 1308 may likewise be transformed to visually represent changes in the underlying data. Display subsystem 1308 may include one or more display devices utilizing virtually any type of technology. Such display devices may be combined with logic machine 1302 and/or storage machine 1304 in a shared enclosure, or such display devices may be peripheral display devices.

When included, input subsystem 1310 may comprise or interface with one or more user-input devices such as a keyboard, mouse, touch screen, or game controller. In some embodiments, the input subsystem 1310 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1312 may be configured to communicatively couple computing system 1300 with one or more other computing devices. Communication subsystem 1312 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1300 to send and/or receive messages to and/or from other devices via a network such as the Internet.

Another example provides an indirect time-of-flight camera system for operating in multiple optical channels using active modulated light. The camera system comprises first and second modulatable laser sources for illuminating a target environment, wherein the first modulatable laser source outputs light of a first wavelength and the second modulatable laser source outputs light of a second wavelength. The camera system further comprises a wavelength-selective reflective element designed to reflect the light of the first wavelength and to transmit the light of the second wavelength. The camera system further comprises a controller comprising instructions executable to control the camera system to, in a first time period, activate the first modulatable laser source and deactivate the second modulatable laser source, and, in a second time period, deactivate the first modulatable laser source and activate the second modulatable laser source. The camera system further comprises a photosensor for receiving the light of the first wavelength during the first time period and for receiving the light of the second wavelength during the second time period. In this example, additionally or alternatively, the camera system further comprises a modulatable third laser source for outputting light of a third wavelength and a second wavelength-selective reflective element designed to reflect the light of the second wavelength and to transmit the light of the third wavelength, wherein the controller further comprises instructions executable to control the camera system to, in a third time period, deactivate the first and second modulatable laser sources and activate the third modulatable laser source, and wherein the photosensor is designed to receive the light of the third wavelength during the third time period. In this example, additionally or alternatively, the wavelength-selective reflective element comprises one or more of a dichroic mirror or a reflection grating. In this example, additionally or alternatively, the camera system further comprises a mirror for redirecting the light of the second wavelength towards the wavelength-selective reflective element. In this example, additionally or alternatively, the first modulatable laser source illuminates the target environment over a first field-of view and the second modulatable laser source illuminates the target environment over a second field-of-view different from the first field-of-view. In this example, additionally or alternatively, the first and second field-of-views at least partially overlap. In this example, additionally or alternatively, the first wavelength is in the near infrared wavelength band.

Another example provides an indirect time-of-flight camera system for operating in multiple optical channels using active modulated light. The camera system comprises at least one modulatable laser source for outputting light of at least a first wavelength to illuminate a target environment. The camera system further comprises a switchable reflective element having first and second states, wherein, in the first state, the switchable reflective element is designed to at least partially transmit the light outputted by the at least one modulatable laser source, and, in the second state, the switchable reflective element is designed to at least partially reflect the light outputted by the at least one modulatable laser source. The camera system further comprises a controller comprising instructions executable to control the camera system to, in a first time period, switch the switchable reflective element to the first state, and, in a second time period, switch the switchable reflective element to the second state. The camera system further comprises a photosensor for receiving the light outputted by the at least one modulatable laser source. In this example, additionally or alternatively, the at least one modulatable laser source includes first and second modulatable laser sources for outputting light of the first wavelength, and the photosensor is designed to receive the light of the first wavelength outputted by the first modulatable laser source during the first time period and to receive the light of the first wavelength outputted by the second modulatable laser source during the second time period. In this example, additionally or alternatively, the camera system further comprises a mirror for redirecting the light of the first wavelength outputted by the second modulatable laser source towards the switchable reflective element. In this example, additionally or alternatively, the switchable reflective element comprises one or more of a switchable mirror or a switchable volume Bragg grating. In this example, additionally or alternatively, the first modulatable laser source illuminates the target environment over a first field-of view and the second modulatable laser source illuminates the target environment over a second field-of-view different from the first field-of-view. In this example, additionally or alternatively, the first and second field-of-views at least partially overlap. In this example, additionally or alternatively, the first wavelength is in the shortwave infrared wavelength band. In this example, additionally or alternatively, the switchable reflective element comprises a switchable holographic chirped grating.

Another example provides a method of operating an indirect time-of-flight camera system. The method comprises projecting modulated light of a first wavelength to illuminate a target environment. The method further comprises transmitting the modulated light of the first wavelength through a first wavelength-selective reflective element, wherein the modulated light of the first wavelength is reflected off the illuminated target environment. The method further comprises, using a photosensor, receiving the transmitted modulated light of the first wavelength. The method further comprises projecting modulated light of a second wavelength to illuminate the target environment. The method further comprises reflecting the modulated light of the second wavelength off the first wavelength-selective reflective element, wherein the modulated light of the second wavelength is reflected off the illuminated target environment. The method further comprises, using the photosensor, receiving the reflected modulated light of the second wavelength. In this example, additionally or alternatively, the method further comprises, using a reflective element, reflecting the modulated light of the second wavelength towards the first wavelength-selective reflective element. In this example, additionally or alternatively, the method further comprises projecting modulated light of a third wavelength to illuminate the target environment, transmitting the modulated light of the third wavelength through a second wavelength-selective reflective element, reflecting the modulated light of the third wavelength off the first wavelength-selective reflective element, and, using the photosensor, receiving the reflected modulated light of the third wavelength. In this example, additionally or alternatively, the modulated light of the first wavelength illuminates the target environment over a first field-of-view and the modulated light of the second wavelength illuminates the target environment over a second field-of-view different from the first field-of-view. In this example, additionally or alternatively, the first wavelength is in the near infrared wavelength band.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An indirect time-of-flight camera system for operating in multiple optical channels using active modulated light, the camera system comprising:
first and second modulatable laser sources for illuminating a target environment, wherein the first modulatable laser source outputs light of a first wavelength and the second modulatable laser source outputs light of a second wavelength;
a wavelength-selective reflective element designed to reflect the light of the first wavelength and to transmit the light of the second wavelength;
a controller comprising instructions executable to control the camera system to:
in a first time period, activate the first modulatable laser source and deactivate the second modulatable laser source; and
in a second time period, deactivate the first modulatable laser source and activate the second modulatable laser source; and
a photosensor for receiving the light of the first wavelength during the first time period and for receiving the light of the second wavelength during the second time period.

2. The camera system of claim 1, further comprising:
a modulatable third laser source for outputting light of a third wavelength; and
a second wavelength-selective reflective element designed to reflect the light of the second wavelength and to transmit the light of the third wavelength;
wherein:
the controller further comprises instructions executable to control the camera system to, in a third time period, deactivate the first and second modulatable laser sources and activate the third modulatable laser source; and
the photosensor is designed to receive the light of the third wavelength during the third time period.

3. The camera system of claim 1, wherein the wavelength-selective reflective element comprises one or more of a dichroic mirror or a reflection grating.

4. The camera system of claim 1, further comprising a mirror for redirecting the light of the second wavelength towards the wavelength-selective reflective element.

5. The camera system of claim 1, wherein the first modulatable laser source illuminates the target environment over a first field-of view and the second modulatable laser source illuminates the target environment over a second field-of-view different from the first field-of-view.

6. The camera system of claim 5, wherein the first and second field-of-views at least partially overlap.

7. The camera system of claim 1, wherein the first wavelength is in the near infrared wavelength band.

8. An indirect time-of-flight camera system for operating in multiple optical channels using active modulated light, the camera system comprising:
at least one modulatable laser source for outputting light of at least a first wavelength to illuminate a target environment;
a switchable reflective element having first and second states, wherein:
in the first state, the switchable reflective element is designed to at least partially transmit the light outputted by the at least one modulatable laser source; and
in the second state, the switchable reflective element is designed to at least partially reflect the light outputted by the at least one modulatable laser source;
a controller comprising instructions executable to control the camera system to:
in a first time period, switch the switchable reflective element to the first state; and
in a second time period, switch the switchable reflective element to the second state; and
a photosensor for receiving the light outputted by the at least one modulatable laser source.

9. The camera system of claim 8, wherein:
the at least one modulatable laser source includes first and second modulatable laser sources for outputting light of the first wavelength; and
the photosensor is designed to receive the light of the first wavelength outputted by the first modulatable laser source during the first time period and to receive the light of the first wavelength outputted by the second modulatable laser source during the second time period.

10. The camera system of claim 9, further comprising a mirror for redirecting the light of the first wavelength outputted by the second modulatable laser source towards the switchable reflective element.

11. The camera system of claim 8, wherein the switchable reflective element comprises one or more of a switchable mirror or a switchable volume Bragg grating.

12. The camera system of claim 8, wherein the first modulatable laser source illuminates the target environment over a first field-of view and the second modulatable laser source illuminates the target environment over a second field-of-view different from the first field-of-view.

13. The camera system of claim 12, wherein the first and second field-of-views at least partially overlap.

14. The camera system of claim 8, wherein the first wavelength is in the shortwave infrared wavelength band.

15. The camera system of claim 8, wherein the switchable reflective element comprises a switchable holographic chirped grating.

16. A method of operating an indirect time-of-flight camera system, the method comprising:
projecting modulated light of a first wavelength to illuminate a target environment;
transmitting the modulated light of the first wavelength through a first wavelength-selective reflective element, wherein the modulated light of the first wavelength is reflected off the illuminated target environment;
using a photosensor, receiving the transmitted modulated light of the first wavelength;
projecting modulated light of a second wavelength to illuminate the target environment;
reflecting the modulated light of the second wavelength off the first wavelength-selective reflective element, wherein the modulated light of the second wavelength is reflected off the illuminated target environment; and
using the photosensor, receiving the reflected modulated light of the second wavelength.

17. The method of claim 16, further comprising:
using a reflective element, reflecting the modulated light of the second wavelength towards the first wavelength-selective reflective element.

18. The method of claim 16, further comprising:
projecting modulated light of a third wavelength to illuminate the target environment;
transmitting the modulated light of the third wavelength through a second wavelength-selective reflective element;
reflecting the modulated light of the third wavelength off the first wavelength-selective reflective element; and
using the photosensor, receiving the reflected modulated light of the third wavelength.

19. The method of claim 16, wherein the modulated light of the first wavelength illuminates the target environment over a first field-of-view and the modulated light of the second wavelength illuminates the target environment over a second field-of-view different from the first field-of-view.

20. The method of claim 16, wherein the first wavelength is in the near infrared wavelength band.
